(19) United States
(12) Patent Application Publication
(10) Pub. No.: US 2017/0026735 A1
(43) Pub. Date: Jan. 26, 2017

(54) GESTURE CONTROL EARPHONE

(71) Applicants: Haouyu Li, Shanghai (CN); Hunglin Hsu, Shanghai (CN); Liying Hu, Shanghai (CN); Shufen Guo, Shanghai (CN); Rongjian Huang, Shanghai (CN)

(72) Inventors: Haouyu Li, Shanghai (CN); Hunglin Hsu, Shanghai (CN); Liying Hu, Shanghai (CN); Shufen Guo, Shanghai (CN); Rongjian Huang, Shanghai (CN)

(73) Assignee: Harman International Industries, Incorporated, Stamford, CT (US)

(21) Appl. No.: 15/125,002

(22) PCT Filed: Mar. 31, 2014
(86) PCT No.: PCT/CN2014/074373

§ 371 Date: Sep. 9, 2016

(51) Int. Cl. H04R 1/10; G06F 3/16; G06F 3/01

(52) U.S. Cl. CPC H04R 1/1041; G06F 3/017; G06F 3/165

(57) ABSTRACT

An earphone and a media player system are provided. The earphone may include: a first sensor unit and a second sensor unit respectively mounted on a left portion and a right portion of the earphone, adapted to sensing gestures and generating signals according to the sensed gestures, where the left portion and the right portion are disposed on two sides of a user's head when the user wears the earphone; a processing device, adapted to translating the signals into control instructions to control a media player; and an interface, adapted to transmitting the control instructions to the media player. Unintended operations may be reduced.

### TECHNICAL FIELD

The present disclosure generally relates to an earphone, and more particularly, to a gesture control earphone.

### BACKGROUND

When in use, an earphone is normally attached to a media player through a cord equipped with a remote, such that a user can control the media player by operating the remote, which is more convenient than operating the media player to control playback. However, remote operation still need eye attention and hand control, which may be cumbersome in some occasions. For example, when people are doing sports, it is very inconvenient to operate buttons on the remote. Therefore, easier ways to control the playback of media players are required.

### SUMMARY

In one embodiment, an earphone is provided. The earphone may include: a first sensor unit and a second sensor unit respectively mounted on a left portion and a right portion of the earphone, adapted to sensing gestures and generating signals according to the sensed gestures, where the left portion and the right portion are disposed on the left and the right sides of a user's head respectively when the user wears the earphone; a processing device, adapted to translating the signals into control instructions to control a media player; and an interface, adapted to transmitting the control instructions to the media player.

In some embodiments, the first sensor unit may be mounted on a left earpiece of the earphone, and the second sensor unit may be mounted on a right earpiece of the earphone.

In some embodiments, the first sensor unit and the second sensor unit may include at least one infrared sensor, at least one capacitance sensor, or any combination thereof.

In some embodiments, the processing device may be configured to: translate a first signal, generated by one of the first and the second sensor units upon sensing a first gesture, into a first control instruction to control the media player to play a next file, where the first gesture includes waving over the sensor unit that generates the first signal along a first direction followed by waving over the sensor unit that generates the first signal along a second direction within a first predetermined period of time, where the first direction and the second direction are substantially opposite to each other.

In some embodiments, the processing device may be configured to: translate a second signal, generated by one of the first and the second sensor units upon sensing a second gesture, into a second control instruction to control the media player to play a previous file, where the second gesture includes waving over the sensor unit that generates the second signal along a third direction followed by waving over the sensor unit that generates the second signal along a fourth direction within a second predetermined period of time, where the third direction and the fourth direction are substantially opposite to each other.

In some embodiments, both the first signal and the second signal may be generated by one of the first and the second sensor units.

In some embodiments, the first direction may be forward and the second direction may be backward. In some embodiments, the third direction may be backward and the fourth direction may be forward.

In some embodiments, the processing device may be configured to: translate a third signal, generated by one of the first and the second sensor units upon sensing a third gesture, into a third control instruction to control the media player to play or pause, where the third gesture includes waving over the sensor unit that generates the third signal along a fifth direction followed by waving over the sensor unit that generates the third sensor unit along a sixth direction within a third predetermined period of time, where the fifth direction and the sixth direction are substantially opposite to each other.

In some embodiments, the processing device may be configured to: translate a fourth signal, generated by the first sensor unit upon sensing a fourth gesture, into a fourth control instruction, where the fourth gesture includes the user's hand staying in a sensing range of the first sensor unit for at least a fourth predetermined period of time; and translate a fifth signal, generated by the second sensor unit upon sensing a fifth gesture, into a fifth control instruction, where the fifth gesture includes the user's hand staying in a sensing range of the second sensor unit for at least a fifth predetermined period of time, where one of the fourth and the fifth control instructions is used to control the media player to increase volume, and the other one of the fourth and the fifth control instructions is used to control the media player to decrease volume.

In some embodiments, each one of the fourth and the fifth control instructions controls the media player to increase or decrease volume to an extent based on how long the user's hand stays in its sensing range.

In some embodiments, the interface may transmit the control instruction to the media player through a cord. In some embodiments, the interface may transmit the control instruction to the media player using wireless connection.

In one embodiment, a media player system is provided. The media player system may include an earphone and a media player. The earphone may include: a first sensor unit and a second sensor unit respectively mounted on a left portion and a right portion of the earphone, adapted to sensing gestures and generating signals according to the sensed gestures, where the left portion and the right portion are disposed on the left and the right sides of a user's head respectively when the user wears the earphone; and an interface adapted to transmitting the signals to the media player. The media player may include a processing device adapted to translating the signals into control instructions to control the media player.

In some embodiments, the first sensor unit may be mounted on a left earpiece of the earphone, and the second sensor unit may be mounted on a right earpiece of the earphone.

In some embodiments, the first sensor unit and the second sensor unit may include at least one infrared sensor, at least one capacitance sensor, or any combination thereof.

In some embodiments, the processing device may be configured to: translate a first signal, generated by one of the first and the second sensor units upon sensing a first gesture, into a first control instruction to control the media player to play a next file, where the first gesture includes waving over the sensor unit that generates the first signal along a first direction followed by waving over the sensor unit that generates the first signal along a second direction within a first predetermined period of time, where the first direction and the second direction are substantially opposite to each other.

In some embodiments, the processing device may be configured to: translate a second signal, generated by one of the first and the second sensor units upon sensing a second gesture, into a second control instruction to control the media player to play a previous file, where the second gesture includes waving over the sensor unit that generates the second signal along a third direction followed by waving over the sensor unit that generates the second signal along a fourth direction within a second predetermined period of time, where the third direction and the fourth direction are substantially opposite to each other.

In some embodiments, both the first signal and the second signal may be generated by one of the first and the second sensor units.

In some embodiments, the first direction may be forward and the second direction may be backward. In some embodiments, the third direction may be backward and the fourth direction may be forward.

In some embodiments, the processing device may be configured to: translate a third signal, generated by one of the first and the second sensor units upon sensing a third gesture, into a third control instruction to control the media player to play or pause, where the third gesture includes waving over the sensor unit that generates the third signal along a fifth direction followed by waving over the sensor unit that generates the third sensor unit along a sixth direction within a third predetermined period of time, where the fifth direction and the sixth direction are substantially opposite to each other.

In some embodiments, the processing device may be configured to: translate a fourth signal, generated by the first sensor unit upon sensing a fourth gesture, into a fourth control instruction, where the fourth gesture includes the user's hand staying in a sensing range of the first sensor unit for at least a fourth predetermined period of time; and translate a fifth signal, generated by the second sensor unit upon sensing a fifth gesture, into a fifth control instruction, where the fifth gesture includes the user's hand staying in a sensing range of the second sensor unit for at least a fifth predetermined period of time, where one of the fourth and the fifth control instructions is used to control the media player to increase volume, and the other one of the fourth and the fifth control instructions is used to control the media player to decrease volume.

In some embodiments, each one of the fourth and the fifth control instructions controls the media player to increase or decrease volume to an extent based on how long the user's hand stays in its sensing range.

In some embodiments, the interface may transmit the signals to the media player through a cord. In some embodiments, the interface may transmit the signals to the media player using wireless connection.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 schematically illustrates an earphone according to one embodiment.

FIG. 2 schematically illustrates a block diagram of a media player system according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

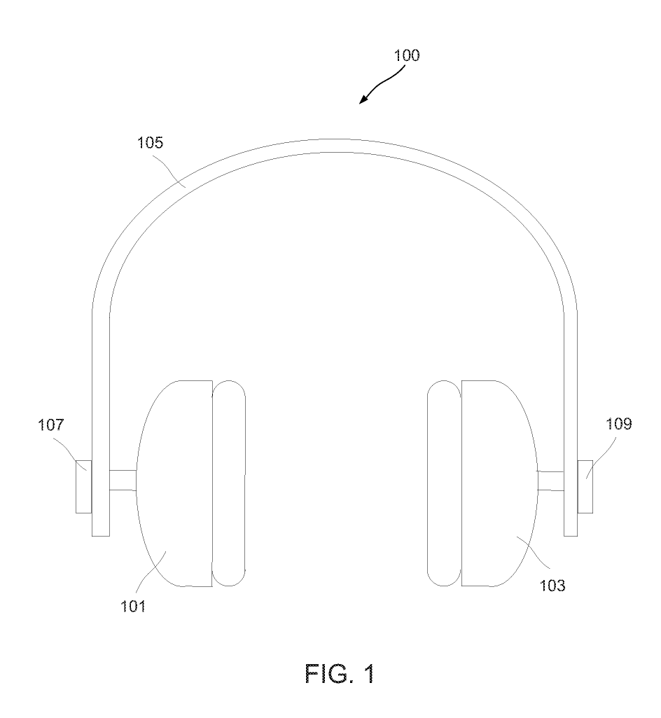

FIG. 1 schematically illustrates an earphone 100 according to one embodiment. Referring to FIG. 1, the earphone 100 includes a left earpiece 101, a right earpiece 103, a head strip 105 for connecting the left and right earpieces 101 and 103, a first sensor unit 107 and a second sensor unit 109.

FIG. 1 illustrates an embodiment of a headset, which is a kind of earphone. It should be noted that embodiments of the present disclosure are not limited to headset. Various kinds of earphones are practical, as long as they have two components respectively to be inserted into or attached to left and right ears of a user.

The first and the second sensor units 107 and 109 can sense gestures and generate signals corresponding to the sensed gestures. In the present disclosure, gestures may include any action which may can be sensed by the first and the second sensor units 107 and 109, for example but not limited to, conducting an action or staying still within a sensing range of the sensor units, exerting pressure or sliding on the sensor units, or the like.

As shown in FIG. 1, the first and the second sensor units 107 and 109 may be mounted on the head strip 105 and are respectively close to the left and right earpieces 101 and 103. Therefore, when a user wears the earphone 100, the first and the second sensor units 107 and 109 can be respectively disposed near the user's left ear and right ear. In some embodiments, the first and the second sensor units 107 and 109 may be mounted on the shells of the earpieces or inside of the chambers of the left and right earpieces 101 and 103, as long as the first and the second sensor units 107 and 109 can be disposed on two sides of the user's head when the user wears the earphone 100. Normally, a gesture for controlling an earphone may be conducted by one or two hands of the user. Since the first and the second sensor units 107 and 109 are disposed on two sides of the user's head, the user can conveniently use his/her hand(s) to conduct specific gesture(s). Disturbance may be reduced, as the two sensor units are disposed relatively far away from each other, and gestures conducted on two sides of the user's head may not easily disturb each other. Furthermore, it's less possible for a man to lift one or two hands up over the shoulders than to move the hands below the shoulders. In some occasions such as when the user is doing sports, the earpieces or the stripe can be attached steadily to the user's head, while other components like cord may swing with the user's body movement. It may be easier for the sensor units to detect specific gestures if they are mounted on the relatively stable components. Therefore, unintended operations may be reduced.

It should be noted that, positions of the first and the second sensor units 107 and 109 may be interchanged. That is to say, in some embodiments, the first sensor unit 107 may be mounted on or close to the right earpiece 101, and the second sensor unit 109 may be mounted on or close to the left earpiece 103.

In some embodiments, each of the first and the second sensor units 107 and 109 may include an infrared sensor, or an array of infrared sensors. Infrared sensors can detect a shelter appearing in their sensing ranges. Therefore, once the user's hand(s) moves close to one of the first and the second sensor units 107 and 109, a corresponding signal may be generated, which may contain information of when and how long infrared radiation was blocked.

In some embodiments, each of the first and the second sensor units 107 and 109 may include a capacitance sensor, or an array of capacitance sensors. Capacitance sensors can sense capacitance change caused by human skins, such that the user's hand actions inside of one of sensing ranges of the first and the second sensor units 107 and 109 may stimulate corresponding signals. Compared with infrared sensors, capacitance sensors won't be stimulated by hair or cloth sheltering, thus unintended inputs may be reduced. Further, capacitance sensors can detect object track, proximity, position, etc., such that more options for gesture controls can be realized.

It should be noted that the first and the second sensor units 107 and 109 may include the same or different types of sensors. Any combinations of the above described sensors or other sensors may be selected based on practical requirements.

The user may post a specific gesture in order to control playback of a media player cooperating with the earphone. Translations may be necessary to generate, based on signals generated by the first and the second sensor units 107 and 109, control instructions which can be recognized by the media player to implement corresponding operations. In some embodiments, a processing device may be equipped to implement the translations.

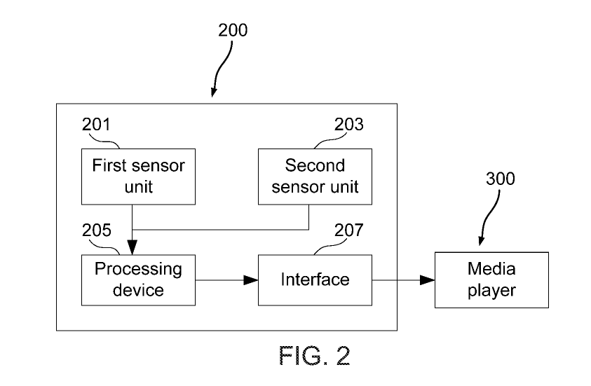

FIG. 2 schematically illustrates a block diagram of a media player system according to one embodiment. As shown in FIG. 2, the system may include an earphone 200 and a media player 300. The earphone 200 may include a first sensor unit 201, a second sensor unit 203, a processing device 205 and an interface 207. the first and the second sensor units 201 and 203 may sense a user's gestures and generate corresponding signals, detail information of which can be found by referring to above descriptions of sensor units. The processing device 205 may translate the signals generated by the first and the second sensor units 201 and 203 into control instructions which are readable for the media player 300. And the interface 207 may transmit the control instruction to the media player 300.

In some embodiments, the interface 207 may include a cord ended with a plug to be inserted into a corresponding port mounted on the media player 300, such that communications can be implemented between the earphone 200 and the media player 300 through the cord. In some embodiments, the interface 207 may include a wireless communication device which communicates with the media player 300 using wireless connections like Bluetooth, Wi-Fi, etc.

FIG. 2 illustrates an embodiment in which the translations from sensor signals into control instructions are implemented in the earphone 200. However, it should be noted that the translations may be implemented in the media player 300. In some embodiments, the processing device 205 may be embedded in the media player 300, and the interface 207 may be adapted to transmitting signals generated by the first sensor unit 201 and the second sensor unit 203 to the media player 300, such that the media player 300 can implement the translations using its own component, i.e., the processing device 205.

The processing device 205 may generate control instructions based on the signals generated by the first sensor unit 201 and the second sensor unit 203. Different gestures may stimulate different signals corresponding to different operations. In some embodiments, a lookup table may be pre-established, in which mappings between signals and control instructions are established. As such, once the processing device 205 receives a signal from the first sensor unit 201 or the second sensor unit 203, or singles from both the first sensor unit 201 and the second sensor unit 203, it may generate a corresponding control instruction based on the mapping. It could be understood that if a gesture stimulates a signal which is not listed in the lookup table, this gesture may not cause any result on the playback operation. That is to say, the media player system may only accept signals caused by predetermined gestures.

Hereinafter gives some examples of predetermined gestures and playback operations caused by these predetermined gestures.

In some embodiments, waving over the first sensor unit 201 along a first direction followed by waving over the first sensor unit 201 along a second direction substantially opposite to the first direction within a first predetermined period of time may be pre-defined as a first gesture. “Wave” means an object, normally the user's hand, entering into the sensing range of a sensor and quickly moving out of the range. How long the object can stay in the sensing range may be predetermined. Normally a very short time may be pre-set. If the object stays in the sensing range longer than the pre-set short time, the gesture may not be identified as a “wave”. For example, if the user moves one hand from back to front aside his/her head, it may be identified as a “wave” by the system. In some embodiments, the first predetermined period of time may be set as a relatively short period of time, such as 1 or 2 seconds. Therefore, if the user's hand waves over the first sensor unit 201 along the first direction and quickly turns back, i.e., waves over the first sensor unit 201 along the second direction, the first sensor unit 201 may generate a first signal upon sensing such gesture. The processing device 205 may translate the first signal into a first control instruction to control the media player 300 to play a next file. In some embodiments, the first direction may be forward and the second direction may be backward.

Since it's less possible for an object randomly passing by the user twice in a short time and along particular directions, respectively, unintended signal inputs may be reduced. Similar gesture may also stimulate the second sensor unit 203 mounted on the right earpiece to generate a signal, such that another operation like skipping tracks can be realized. In some embodiments, waving over the second sensor unit 203 along a third direction followed by waving over the second sensor unit 203 along a fourth direction within a second predetermined period of time may be defined as a second gesture. The second sensor unit 203 may generate a second signal upon sensing the second gesture, and the processing device 205 may translate the second signal into a second control instruction to control the media player 300 to play a previous file. The third direction and the fourth direction may be substantially opposite to each other. The third direction and the fourth direction may be set as the same as the first direction and the second direction, since the first gesture and the second gesture are set as to be sensed by different sensor units and the processing device 205 is able to tell the first and second signals apart. In some embodiments, the second gesture may be set as to be sensed by the first sensor unit 201, i.e., the second gesture may include waving over the first sensor unit 201 along the third direction followed by waving over the first sensor unit 201 along the fourth direction. In such configurations, the third direction and the fourth direction may not be set as the same as the first direction and the second direction. In some embodiments, the third direction may be backward and the fourth direction may be forward. Such that, the user can control the media player to player a next file or a previous file by conducting over the same sensor unit the first gesture or the second gesture which are substantially opposite to each other. User experience may be improved.

In some embodiments, waving over one of the first and the second sensor unit 201 and 203 along a fifth direction followed by waving over the same sensor unit along a sixth direction may be predefined as a third gesture. The fifth direction and the sixth direction may be substantially opposite to each other. The third gesture may be pre-defined to be sensed by either the first sensor unit 201 or the second sensor unit 203. In some embodiments, if the first sensor unit 201 is configured to sense the first and second gestures, the second sensor unit 203 may be configured to sense the third gesture. Upon sensing the third gesture, the second sensor unit 203 may generate a third signal. The processing device 205 may translate the third signal into a third instruction to control the media player 300 to play or pause.

In some embodiments, if the user's hand staying in a sensing range of the first sensor unit 201 for at least a fourth predetermined period of time, the first sensor unit 201 may generate a fourth signal; and if the user's hand staying in a sensing range of the second unit 203 for a fifth predetermined period of time, the second sensor unit 203 may generate a fifth signal. The processing device 205 may translate the fourth signal and the fifth signal into a fourth control instruction and a fifth control instruction. One of the fourth and the fifth control instructions may be used to control the media player 300 to increase volume, and the other one may be used to control the media player 300 to decrease volume. Since both the first and the second sensor units 201 and 203 can detect how long the user's hand stays in the corresponding sensing ranges, the processing device 205 may generate the corresponding control instruction to control the media player 300 to increase or decrease the volume to an extent based on how long the user's hand stays in the sensing range of the first sensor unit 201 or the second sensor unit 203.

Further, in some embodiments, above described gestures may be combined. For example, waving over the left and right earpieces together may cause a shuffle operation, and the like.

Mappings between signals and control instructions may be established in advance. That is to say, what gestures can be recognized as intended operations may be predetermined. Once the processing device 205 receives a signal, it may determine whether the signal is caused by a predetermined gesture, i.e., whether there is a mapping between the signal and a control instruction. If no, the processing device 205 may treat the signal as a false input. By setting the above described gestures as acceptable inputs, unintended operations may be reduced.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. An earphone, comprising:
a first sensor unit and a second sensor unit respectively mounted on a left portion and a right portion of the earphone, adapted to sensing gestures and generating signals according to the sensed gestures, where the left portion and the right portion are disposed on the left and the right sides of a user's head respectively when the user wears the earphone;
a processing device, adapted to translating the signals into control instructions to control a media player; and
an interface, adapted to transmitting the control instructions to the media player.

2. The earphone according to claim 1, wherein the first sensor unit is mounted on a left earpiece of the earphone, and the second sensor unit is mounted on a right earpiece of the earphone.

3. The earphone according to claim 1, wherein the processing device is configured to: translate a first signal, generated by one of the first and the second sensor units upon sensing a first gesture, into a first control instruction to control the media player to play a next file, where the first gesture comprises waving over the sensor unit that generates the first signal along a first direction followed by waving over the sensor unit that generates the first signal along a second direction within a first predetermined period of time, where the first direction and the second direction are substantially opposite to each other.

4. The earphone according to claim 1, wherein the processing device is configured to: translate a second signal, generated by one of the first and the second sensor units upon sensing a second gesture, into a second control instruction to control the media player to play a previous file, where the second gesture comprises waving over the sensor unit that generates the second signal along a third direction followed by waving over the sensor unit that generates the second signal along a fourth direction within a second predetermined period of time, where the third direction and the fourth direction are substantially opposite to each other.

5. The earphone according to claim 3, wherein the processing device is configured to: translate a second signal, generated by the sensor unit which also generates the first signal upon sensing a second gesture, into a second control instruction to control the media player to play a previous file, where the second gesture comprises waving over the sensor unit that generates the second signal along a third direction followed by waving over the sensor unit that generates the second signal along a fourth direction within a second predetermined period of time, where the third direction and the fourth direction are substantially opposite to each other.

6. The earphone according to claim 1, wherein the processing device is configured to: translate a third signal, generated by one of the first and the second sensor units upon sensing a third gesture, into a third control instruction to control the media player to play or pause, where the third gesture comprises waving over the sensor unit that generates the third signal along a fifth direction followed by waving over the sensor unit that generates the third sensor unit along a sixth direction within a third predetermined period of time, where the fifth direction and the sixth direction are substantially opposite to each other.

7. The earphone according to claim 1, wherein the processing device is configured to: translate a fourth signal, generated by the first sensor unit upon sensing a fourth gesture, into a fourth control instruction, where the fourth gesture comprises the user's hand staying in a sensing range of the first sensor unit for at least a fourth predetermined period of time; and translate a fifth signal, generated by the second sensor unit upon sensing a fifth gesture, into a fifth control instruction, where the fifth gesture comprises the user's hand staying in a sensing range of the second sensor unit for at least a fifth predetermined period of time, where one of the fourth and the fifth control instructions is used to control the media player to increase volume, and the other one of the fourth and the fifth control instructions is used to control the media player to decrease volume.

8. The earphone according to claim 7, wherein each one of the fourth and the fifth control instructions controls the media player to increase or decrease volume to an extent based on how long the user's hand stays in its sensing range.

9. A media player system, comprising:
an earphone and a media player,
wherein the earphone comprises: a first sensor unit and a second sensor unit respectively mounted on a left portion and a right portion of the earphone, adapted to sensing gestures and generating signals according to the sensed gestures, where the left portion and the right portion are disposed on the left and the right sides of a user's head respectively when the user wears the earphone; and an interface adapted to transmitting the signals to the media player,
wherein the media player comprises a processing device adapted to translating the signals into control instructions to control the media player.

10. The media player system according to claim 9, wherein the first sensor unit is mounted on a left earpiece of the earphone, and the second sensor unit is mounted on a right earpiece of the earphone.

11. The media player system according to claim 9, wherein the processing device is configured to: translate a first signal, generated by one of the first and the second sensor units upon sensing a first gesture, into a first control instruction to control the media player to play a next file, where the first gesture comprises waving over the sensor unit that generates the first signal along a first direction followed by waving over the sensor unit that generates the first signal along a second direction within a first predetermined period of time, where the first direction and the second direction are substantially opposite to each other.

12. The media player system according to claim 9, wherein the processing device is configured to: translate a second signal, generated by one of the first and the second sensor units upon sensing a second gesture, into a second control instruction to control the media player to play a previous file, where the second gesture comprises waving over the sensor unit that generates the second signal along a third direction followed by waving over the sensor unit that generates the second signal along a fourth direction within a second predetermined period of time, where the third direction and the fourth direction are substantially opposite to each other.

13. The media player system according to claim 11, wherein the processing device is configured to: translate a second signal, generated by the sensor unit which also generates the first signal upon sensing a second gesture, into a second control instruction to control the media player to play a previous file, where the second gesture comprises waving over the sensor unit that generates the second signal along a third direction followed by waving over the sensor unit that generates the second signal along a fourth direction within a second predetermined period of time, where the third direction and the fourth direction are substantially opposite to each other.

14. The media player system according to claim 9, wherein the processing device is configured to: translate a third signal, generated by one of the first and the second sensor units upon sensing a third gesture, into a third control instruction to control the media player to play or pause, where the third gesture comprises waving over the sensor unit that generates the third signal along a fifth direction followed by waving over the sensor unit that generates the third sensor unit along a sixth direction within a third predetermined period of time, where the fifth direction and the sixth direction are substantially opposite to each other.

15. The media player system according to claim 9, wherein the processing device is configured to: translate a fourth signal, generated by the first sensor unit upon sensing a fourth gesture, into a fourth control instruction, where the fourth gesture comprises the user's hand staying in a sensing range of the first sensor unit for at least a fourth predetermined period of time; and translate a fifth signal, generated by the second sensor unit upon sensing a fifth gesture, into a fifth control instruction, where the fifth gesture comprises the user's hand staying in a sensing range of the second sensor unit for at least a fifth predetermined period of time, where one of the fourth and the fifth control instructions is used to control the media player to increase volume, and the other one of the fourth and the fifth control instructions is used to control the media player to decrease volume.

16. The media player system according to claim 15, wherein each one of the fourth and the fifth control instructions controls the media player to increase or decrease volume to an extent based on how long the user's hand stays in its sensing range.
